(19) United States
(12) Patent Application Publication
(10) Pub. No.: US 2018/0368638 A1
(43) Pub. Date: Dec. 27, 2018

(54) SEPARATING APPARATUS AND VACUUM CLEANER

(71) Applicant: Dyson Technology Limited, Wiltshire (GB)

(72) Inventor: Antony Owen DEMAUS, Bristol (GB)

(73) Assignee: Dyson Technology Limited, Wiltshire (GB)

(21) Appl. No.: 16/016,110

(22) Filed: Jun. 22, 2018

(30) Foreign Application Priority Data
Jun. 23, 2017 (GB) 1710063.7

(51) Int. Cl. A47L 9/16; B04C 5/185; B04C 5/26; B04C 5/28; B04C 5/103

(52) U.S. Cl. CPC A47L 9/1608; B04C 5/185; B04C 5/26; A47L 9/1658; B04C 5/103; A47L 9/1683; B04C 5/28

(57) ABSTRACT

A separating apparatus for a vacuum cleaner has a cyclonic separating chamber having a separator axis, a shroud disposed within the cyclonic separating chamber, an inner debris collection chamber for collecting debris separated by the cyclonic separating chamber, and an outer debris collection chamber for collecting debris separated by the cyclonic separating chamber. The inner debris collection chamber has a base and a debris outlet in fluid communication with the outer debris collection chamber. A shortest distance between the shroud and the base in a direction parallel to the separator axis is between 40% to 60% of a largest distance between the cyclonic separating chamber and the base in a direction parallel to the separator axis.

### REFERENCE TO RELATED APPLICATIONS

This application claims the priority of United Kingdom Application No. 1710063.7, filed Jun. 23, 2017, the entire contents of which are incorporated herein by reference.

### FIELD OF THE INVENTION

The present invention relates to separating apparatus, and a vacuum cleaner comprising said apparatus.

### BACKGROUND OF THE INVENTION

It has previously been proposed to utilise separating apparatus having inner and outer debris collection bins, with the inner debris collection bin being housed within the outer debris collection bin. However, providing such an arrangement can impact on the volume of debris that can be separated by the separating apparatus.

### SUMMARY OF THE INVENTION

According to a first aspect of the present invention there is provided separating apparatus for a vacuum cleaner, the separating apparatus comprising a cyclonic separating chamber having a separator axis, a shroud disposed within the cyclonic separating chamber, an inner debris collection chamber for collecting debris separated by the cyclonic separating chamber, and an outer debris collection chamber for collecting debris separated by the cyclonic separating chamber, the inner debris collection chamber comprising a base and a debris outlet in fluid communication with the outer debris collection chamber, wherein a shortest distance between the shroud and the base in a direction parallel to the separator axis is between 40% and 60% of a largest distance between the cyclonic separating chamber and the base in a direction parallel to the separator axis.

The separating apparatus according to the first aspect of the present invention is advantageous principally as a shortest distance between the shroud and the base in a direction parallel to the separator axis is between 40% and 60% of a largest distance between the cyclonic separating chamber and the base in a direction parallel to the separator axis. In particular, the inventors have found that there is a compromise to be reached when considering location of the shroud relative to the inner debris collection chamber. A long distance between a base of the inner debris collection chamber and the shroud is desired to prevent re-entrainment of debris into fluid flowing within the cyclonic separating chamber, and to increase the mass of debris that can be collected in the inner and outer debris collection chambers before airflow through the shroud drops. However, a short distance between the base of the inner debris collection chamber and the shroud is desired to provide a compact arrangement.

It has been found that a shortest distance between the shroud and the base in a direction parallel to the separator axis being between 40% and 60% of a largest distance between the cyclonic separating chamber and the base in a direction parallel to the separator axis may allow for collection of relatively high masses of debris before airflow through the shroud drops, and may avoid re-entrainment of significant levels of debris, whilst also maintaining a compact arrangement of the separating apparatus.

The shortest distance between the shroud and the base in a direction parallel to the separator axis may comprise a distance between a lower edge of the shroud and the base in a direction parallel to the separator axis. The largest distance between the cyclonic separating chamber and the base in a direction parallel to the separator axis may comprise a distance between an upper edge of the cyclonic separating chamber and the base in a direction parallel to the separator axis.

A shortest distance between the shroud and the base in a direction parallel to the separator axis may be between 45% and 55% of a largest distance between the cyclonic separating chamber and the base in a direction parallel to the separator axis. In a presently preferred embodiment, the largest distance between the cyclonic separating chamber and the base in a direction parallel to the separator axis may be around 90 mm, whilst a shortest distance between the shroud and the base in a direction parallel to the separator axis may be around 45 mm. Thus in a presently preferred embodiment, a shortest distance between the shroud and the base in a direction parallel to the separator axis may be around 50% of a largest distance between the cyclonic separating chamber and the base in a direction parallel to the separator axis.

A height of the debris outlet in a direction parallel to the separator axis may be between 20 mm and 30 mm. This may be beneficial as this may enable relatively large debris typically picked up by a vacuum cleaner in use to pass from the inner debris collection chamber to the outer debris collection chamber, whilst also reducing the level of turbulent airflow within the outer debris collection chamber. In particular, the larger the size of the debris outlet, the more turbulent the airflow within the outer debris collection chamber, and hence the greater the level of re-entrainment of debris from the outer debris collection chamber. A height of the debris outlet in a direction parallel to the separator axis of between 20 mm and 30 mm may provide a good compromise between enabling passage of larger debris particles, whilst reducing the turbulence of airflow within the outer debris collection chamber.

The inner debris collection chamber may comprise a substantially cylindrical global form. The debris outlet may extend along the inner debris collection chamber in a circumferential manner, for example the debris outlet may extend along a cylindrical wall of the inner debris collection chamber in a circumferential direction. The debris outlet may comprise a central angle of between 90° and 130°. This may be beneficial as a large central angle, ie a large debris outlet, is desired to enable passage of debris and prevent blockages of the debris outlet, yet a large central angle, ie a large debris outlet, may increase turbulent air flow within the outer debris collection chamber, thereby leading to increased re-entrainment of debris due to disturbance of debris within the outer debris collection chamber. A debris outlet having a central angle of between 90° and 130° may be large enough to enable passage of debris without causing blockages, whilst also providing relatively calm airflow within the outer debris collection chamber.

The separating apparatus may comprise a dirty air inlet. The dirty air inlet may have a height in a direction parallel to the separator axis of at least 20 mm. This may be beneficial as larger debris typically collected by a vacuum cleaner may be able to pass freely through the dirty air inlet in use.

A shortest distance between the dirty air inlet and a lowermost edge of the shroud in a direction parallel to the separator axis may be between 0 mm and 15 mm. This may be beneficial as the inventors have found that there is a compromise to be reached when considering location of the shroud relative to the dirty air inlet. A long distance between the dirty air inlet and a lowermost edge of the shroud is necessary to increase the mass of debris that can be collected in the inner and outer debris collections chambers before airflow through the shroud drops, yet a shorter distance between the dirty air inlet and a lowermost edge of the shroud is desired to provide a compact arrangement. It has been found that a shortest distance between the dirty air inlet and a lowermost edge of the shroud of between 0 mm and 15 mm may provide a relatively large mass of debris that can be collected before airflow through the shroud drops, whilst also maintaining a compact arrangement of the separating apparatus.

The shortest distance between the dirty air inlet and a lowermost edge of the shroud may comprise a distance between a lowermost edge of the dirty air inlet and a lowermost edge of the shroud. The shortest distance between the dirty air inlet and a lowermost edge of the shroud may be between 5 mm and 10 mm. The shortest distance between the dirty air inlet and a lowermost edge of the shroud may be at most 10 mm, and this may, for example, be a presently preferred embodiment.

The shroud may comprise a fluid outlet of the cyclonic separating chamber.

The separator axis may comprise an axis about which fluid, for example dirt laden air, flows in a helical manner within the first cyclonic separating unit. The separator axis may, for example, comprise a central separator axis. The separator axis may be co-axial with an axis of the shroud, for example a central longitudinal axis of the shroud. The separator axis may extend in a direction orthogonal to a flat surface of the shroud, for example in a direction between first and second flat surfaces of the shroud.

The debris outlet may enable passage of debris from the inner debris collection chamber to the outer debris collection chamber in use. For example, the debris outlet may enable debris to pass from the inner debris collection chamber to the outer debris collection chamber when dirty air flows through the separating apparatus.

The inner debris collection chamber may be housed within the outer debris collection chamber. For example, the inner and outer debris collection chambers may be arranged in a concentric manner. A distance between a wall of the inner debris collection chamber and a wall of the outer debris collection chamber in a direction orthogonal to the separator axis may be at least 20 mm. This may be beneficial as larger debris typically collected by a vacuum cleaner may be able to pass freely between the inner and outer debris collection chambers in use.

The debris outlet of the inner debris collection chamber may be spaced apart from a debris outlet of the outer debris collection chamber, for example spaced apart along the separator axis. The inner debris collection chamber may comprise a main body, and the debris outlet of the inner debris collection chamber may be formed in the main body. The base may define a lowermost edge of the debris outlet.

A shortest distance between the shroud and the debris outlet in a direction parallel to the separator axis may be between 10 mm and 25 mm. This may be beneficial as the inventors have found that there is a compromise to be reached when considering location of the shroud relative to the debris outlet. A long distance between the shroud and the debris outlet is necessary to increase the mass of debris that can be collected in the inner and outer debris collections chambers before airflow through the shroud drops, yet a shorter distance between the shroud and the debris outlet is desired to provide a compact arrangement. It has been found that a shortest distance between the shroud and the debris outlet in a direction parallel to the separator axis of between 10 mm and 25 mm may provide a relatively large mass of debris that can be collected before airflow through the shroud drops, whilst also maintaining a compact arrangement of the separating apparatus.

The base may selectively define a secondary debris outlet of the inner debris collection chamber. For example, the base may be movable relative to the main body to define a secondary debris outlet of the inner debris collection chamber.

According to a second aspect of the present invention there is provided separating apparatus for a vacuum cleaner, the separating apparatus comprising a cyclonic separating chamber having a separator axis, a dirty air inlet, a shroud disposed within the cyclonic separating chamber, an inner debris collection chamber for collecting debris separated by the cyclonic separating chamber, and an outer debris collection chamber for collecting debris separated by the cyclonic separating chamber, wherein a shortest distance between the dirty air inlet and a lowermost edge of the shroud in a direction parallel to the separator axis is between 0 mm and 15 mm.

The invention according to the second aspect of the present invention may be advantageous as the shortest distance between the dirty air inlet and a lowermost edge of the shroud in a direction parallel to the separator axis is between 0 mm and 15 mm. In particular, the inventors have found that there is a compromise to be reached when considering location of the shroud relative to the dirty air inlet. A long distance between the dirty air inlet and a lowermost edge of the shroud is necessary to increase the mass of debris that can be collected in the inner and outer debris collections chambers before airflow through the shroud drops, yet a shorter distance between the dirty air inlet and a lowermost edge of the shroud is desired to provide a compact arrangement. It has been found that a shortest distance between the dirty air inlet and a lowermost edge of the shroud of between 0 mm and 15 mm may provide a relatively large mass of debris that can be collected before airflow through the shroud drops, whilst also maintaining a compact arrangement of the separating apparatus.

The lowermost edge of the shroud may be spaced apart from the dirty air inlet, for example such that the lowermost edge of the shroud does not coincide with the dirty air inlet. The lowermost edge of the shroud may be located below a lowermost edge of the dirty air inlet in a direction parallel to the separator axis.

According to a third aspect of the present invention there is provided a vacuum cleaner comprising separating apparatus according to the first or second aspects of the present invention.

Preferential features of aspects of the present invention may be equally applied to other aspects of the present invention, where appropriate.

### BRIEF DESCRIPTION OF THE DRAWINGS

In order to better understand the present invention, and to show more clearly how the invention may be put into effect, the invention will now be described, by way of example, with reference to the following drawings:

FIG. 1 is a front perspective view of separating apparatus according to the present invention in an operable condition;

FIG. 2 is a sectional view of the separating apparatus of FIG. 1 taken in the direction A-A indicated in FIG. 1;

FIG. 3 is a rear perspective view of the separating apparatus of FIG. 1 in an operable condition;

FIG. 4 is a side view of the separating apparatus of FIG. 1 in an operable condition;

FIG. 5 is a sectional view of the separating apparatus of FIG. 1 taken in the direction B-B indicated in FIG. 4;

FIG. 6 is a rear perspective view of the separating apparatus of FIG. 1 in an emptying condition;

FIG. 7 is a sectional view of the separating apparatus of FIG. 1 in an emptying condition;

FIG. 8 is a rear perspective view of the separating apparatus of FIG. 1 in a disconnected cleaning condition;

FIG. 9 is a front perspective view of the separating apparatus of FIG. 1 in a disconnected cleaning condition;

FIG. 10 is a rear view of the separating apparatus of FIG. 1 in a disconnected cleaning condition;

FIG. 11 is a rear view of a primary cyclonic separating unit of the separating apparatus of FIG. 1 in an emptying condition;

FIG. 12 is a lower front perspective view of a secondary cyclonic separating unit of the separating apparatus of FIG. 1 in isolation;

FIG. 13 is a first rear upper perspective view of an inner debris collection chamber and actuation mechanism of the separating apparatus of FIG. 1 in a collecting configuration;

FIG. 14 is a second rear upper perspective view of an inner debris collection chamber and actuation mechanism of the separating apparatus of FIG. 1 in a collecting configuration;

FIG. 15 is a rear lower perspective view of an inner debris collection chamber and actuation mechanism of the separating apparatus of FIG. 1 in a collecting configuration;

FIG. 16 is a front upper perspective view of an inner debris collection chamber and actuation mechanism of the separating apparatus of FIG. 1 in a collecting configuration;

FIG. 17 is a rear upper perspective view of an inner debris collection chamber and actuation mechanism of the separating apparatus of FIG. 1 in an emptying configuration;

FIG. 18 is a rear lower perspective view of an inner debris collection chamber and actuation mechanism of the separating apparatus of FIG. 1 in an emptying configuration;

FIG. 19 is a front upper perspective view of an inner debris collection chamber and actuation mechanism of the separating apparatus of FIG. 1 in an emptying configuration;

FIG. 20 is a front perspective view of a vacuum cleaner according to the present invention;

FIG. 21 is a plot of the distance between a lower edge of a shroud and an upper edge of an inner debris collection chamber aperture versus mass of debris separated for separating apparatus according to the present invention; and

FIG. 22 is a plot of the distance between a lower edge of a dirty air inlet and a lower edge of a shroud versus mass of debris separated for separating apparatus according to the present invention.

### DETAILED DESCRIPTION OF THE INVENTION

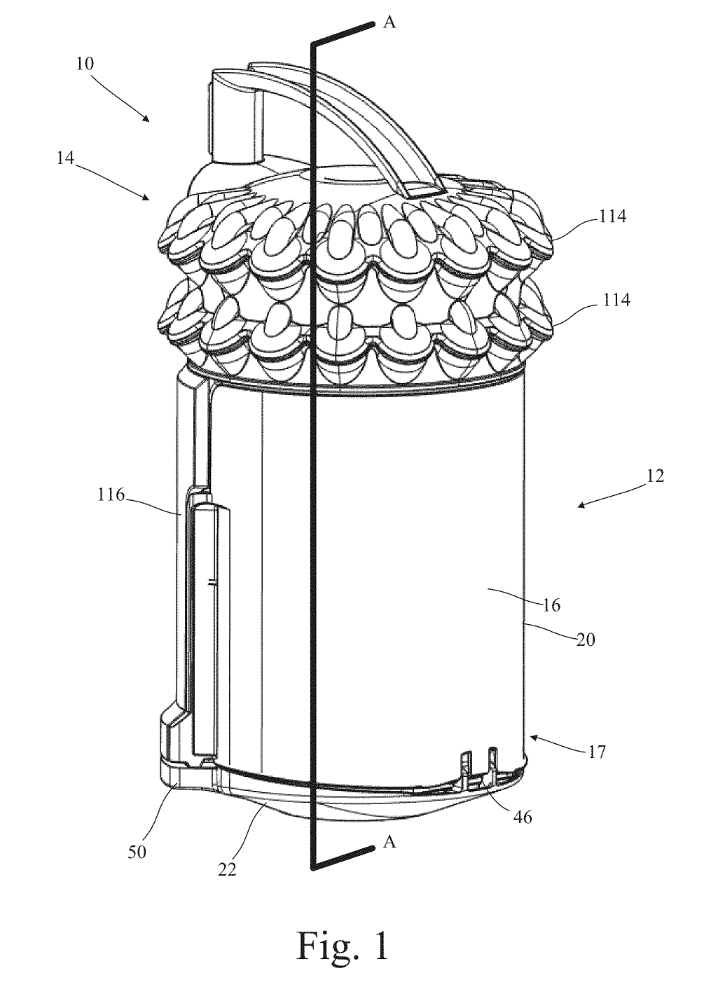

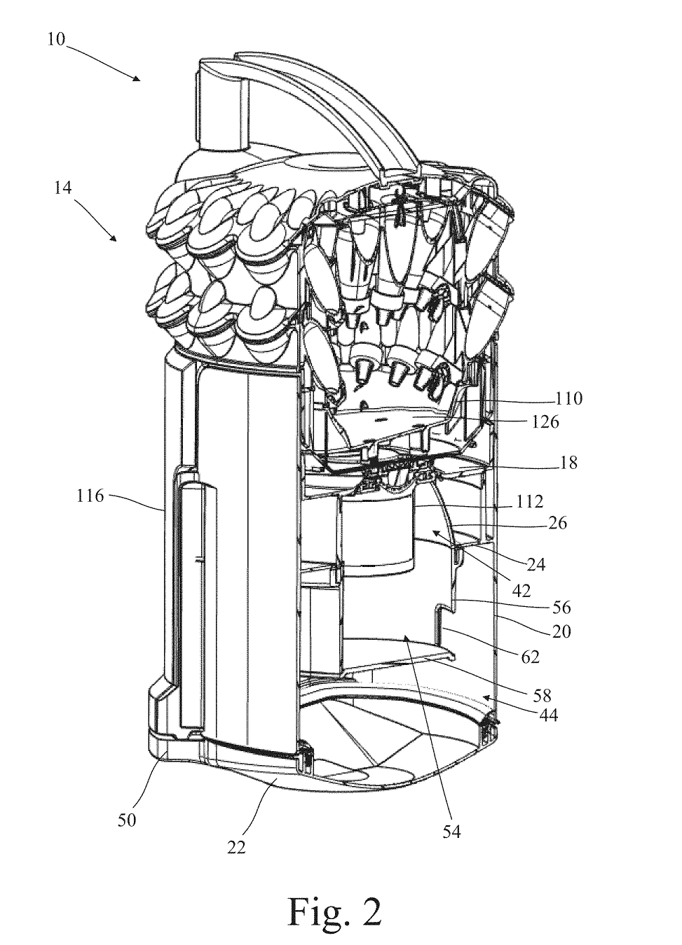

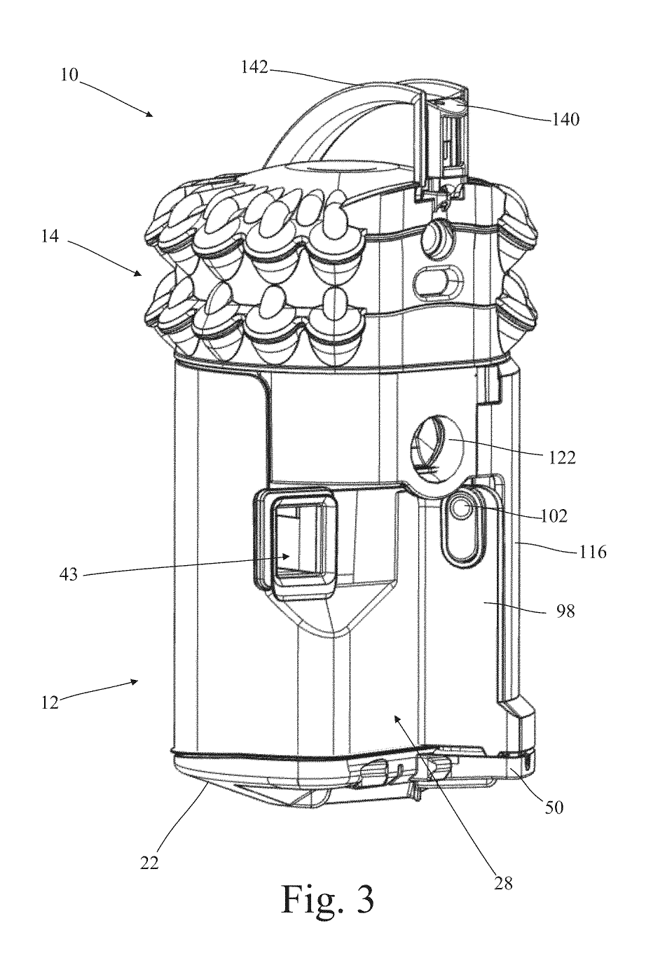

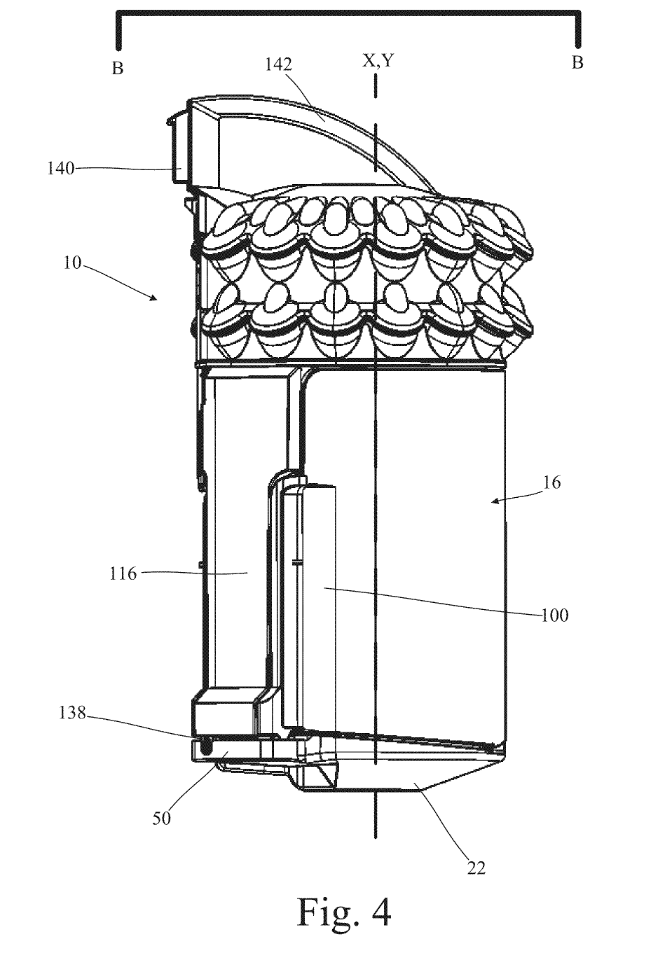

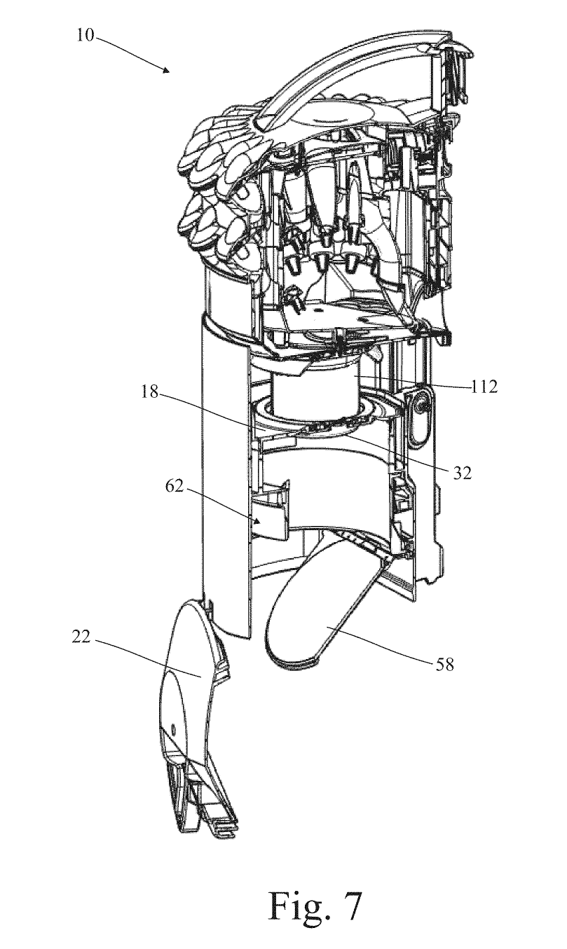

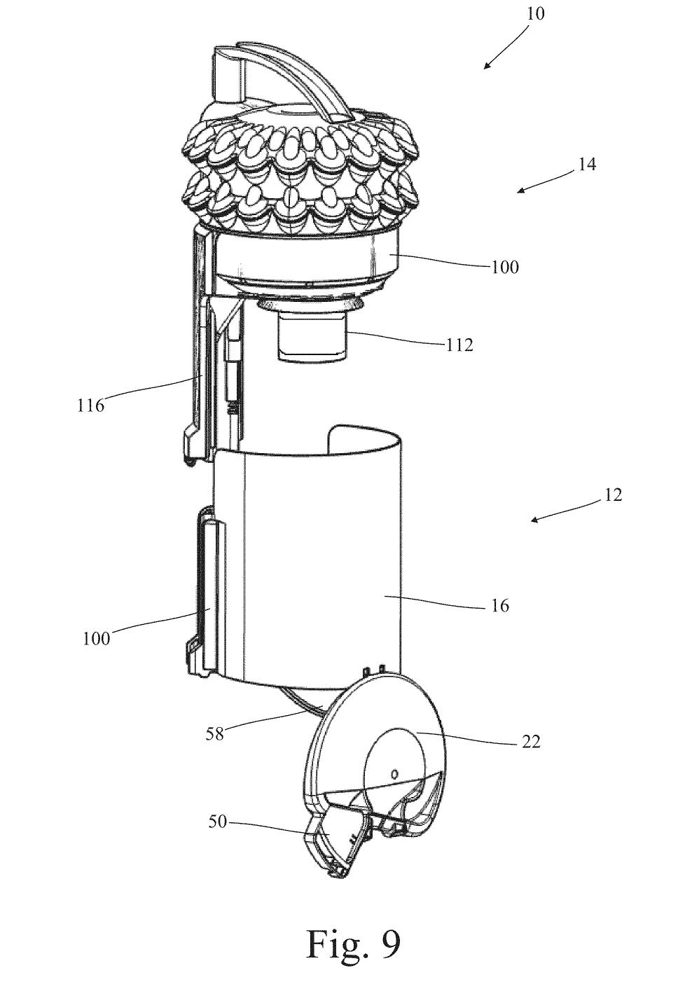

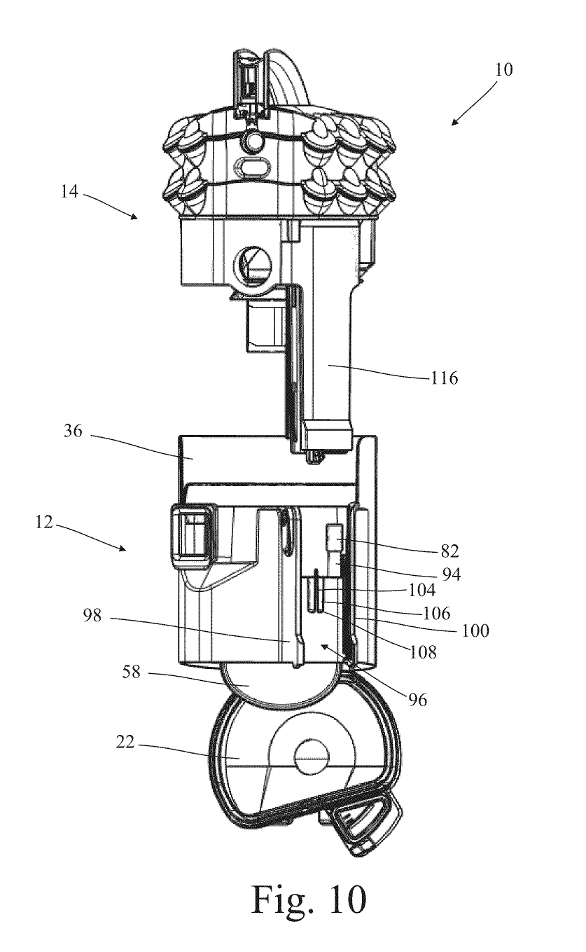

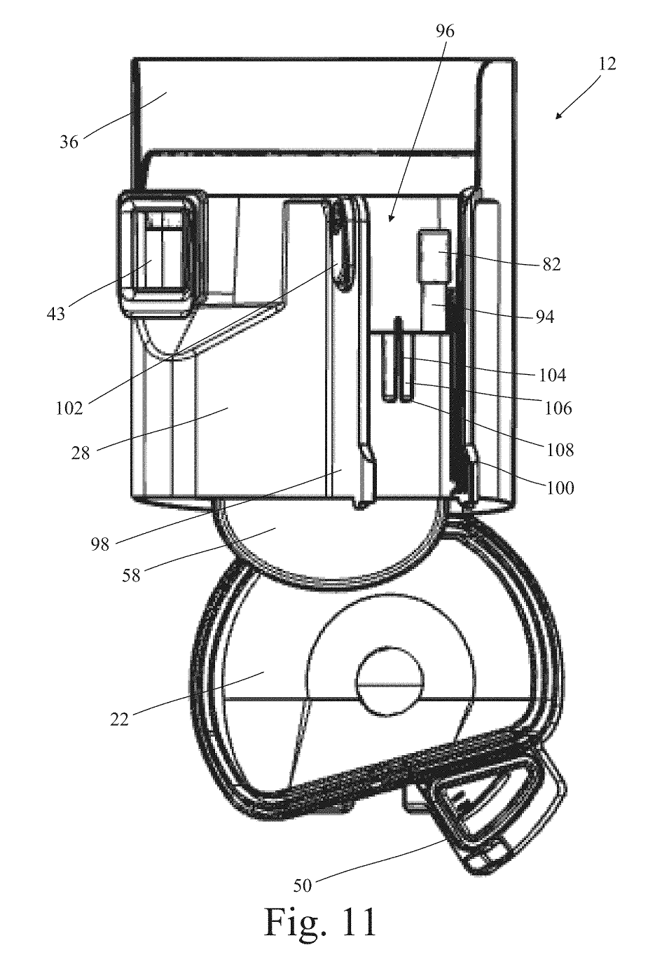

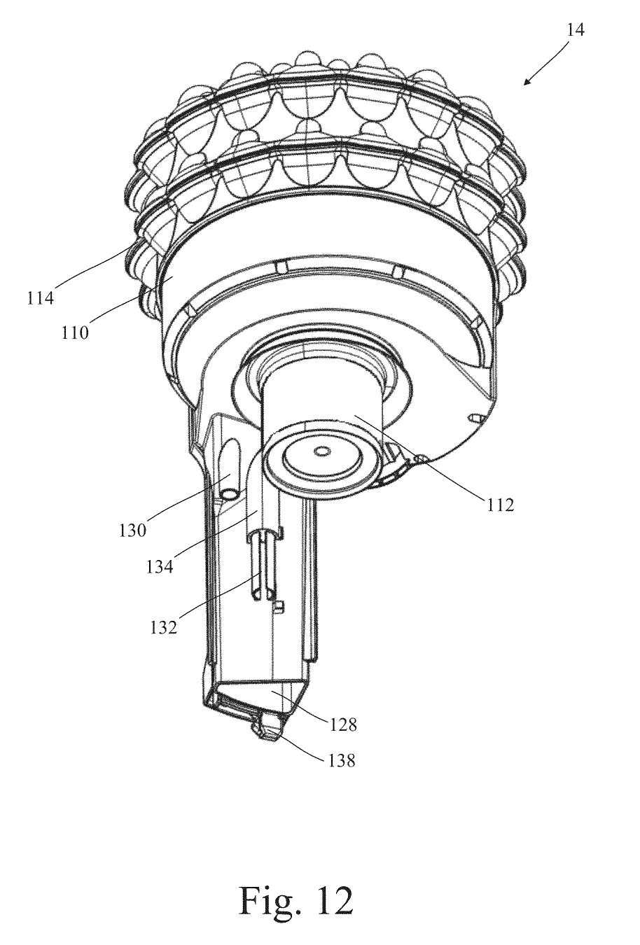

Separating apparatus according to the first aspect of the present invention, generally designated 10, is shown in FIGS. 1-12.

The separating apparatus 10 comprises first 12 and second 14 cyclonic separating units.

The first cyclonic separating unit 12 comprises a bin 16 having an upper wall 18, an outer wall 20, a lower wall 22, an internal dividing wall 24, and an internal separator wall 26.

The outer wall 20 is substantially cylindrical in form, yet comprises a generally flattened rear portion 28, such that the cross-sectional shape of the bin 16 is generally that of a truncated circle.

The upper wall 18 comprises a circular aperture 30 shaped and dimensioned to receive a shroud 112 of the second cyclonic separating unit 14. The diameter of the circular aperture 30 is slightly larger than that of the outer surface of the shroud 112. An annular wipe 32 extends about the perimeter of the circular aperture 30 toward the interior of the bin 16. The annular wipe 32 is obliquely angled relative to the perimeter of the circular aperture 30, such that an innermost edge of the annular wipe 32 has a diameter smaller than that of the circular aperture 30. The diameter of the innermost edge of the annular wipe 32 is substantially equal to the diameter of the outer surface of the shroud 112, such that the innermost edge of the annular wipe 32 contacts an uppermost region of an outer surface of the shroud 112 when the first 12 and second 14 cyclonic separating units are connected in an operable condition.

A locating wall 36, shaped and dimensioned to be received in a corresponding locating recess 120 of the second cyclonic separating unit 14, extends upwardly about the curved perimeter of the upper wall 18.

A first end of the internal separator wall 26 is attached to the outer wall 18, yet the internal separator wall 26 extends within the interior of the bin 16 such that the internal separator wall 26 is spaced apart from the outer wall 18. The internal separator wall 26 extends in a spiral-like manner, through a little over 360°, within the bin 14 between the first end and a second free end. The internal surface of the internal separator wall 26 defines a curved flow path for dirty air within the bin 16.

A cyclonic separating chamber 42 is defined by the upper wall 18, the internal dividing wall 24, and the internal separator wall 26. The cyclonic separating chamber 42 has a separator axis X, about which dirt laden fluid flows in a helical fashion. The internal dividing wall 24 extends about the periphery of the bin 16, such that a lower region of the cyclonic separating chamber 42 is open to define a debris outlet 41 which allows debris separated by the cyclonic separating chamber 42 to fall into a lower region 17 of the bin 16. The first cyclonic separating unit 12 has a dirty air inlet 43 located on a rear surface of the bin 16, adjacent the first end of the internal separator wall 26. Thus, in use, dirty air is directed from the dirty air inlet 43 along the curved flow path defined by the internal surface of the internal separator wall 26, such that the dirty air moves within the cyclonic separating chamber 42 in a helical fashion. Debris separated in the cyclonic separating chamber 42 falls into a lower region 17 of the bin 16 via the debris outlet 41.

The outer wall 20, lower wall 22, and internal dividing wall 24 define an outer debris collection chamber 44 in a lower region 17 of the bin. The lower wall 22 is pivotally connected to the outer wall 20 by an external hinge 46 located on the exterior of the outer wall 20. The lower wall 22 is shaped and dimensioned to correspond to the lower edge of the outer wall 20. An elastomeric peripheral seal (not shown) extends about the periphery of the lower wall 22, such that a seal is formed when the lower wall 22 engages the outer wall 20.

The lower wall 22 has a secondary sealing projection 50 which extends outwardly from the main body of the lower wall 22. The secondary sealing projection 50 has an elastomeric upper surface. The secondary sealing projection 50 is shaped and dimensioned to correspond to an outlet of a fine dirt collection chamber 116 of the second cyclonic separating unit 14, such that in use, when the lower wall 20 closes the bottom of the bin 16, the secondary sealing projection 50 closes the outlet of the fine dirt collection chamber 116 of the second cyclonic separating unit 14. The secondary sealing projection 50 has a latch receiving formation 51 for receiving a latch 138 of the second cyclonic separating unit 14.

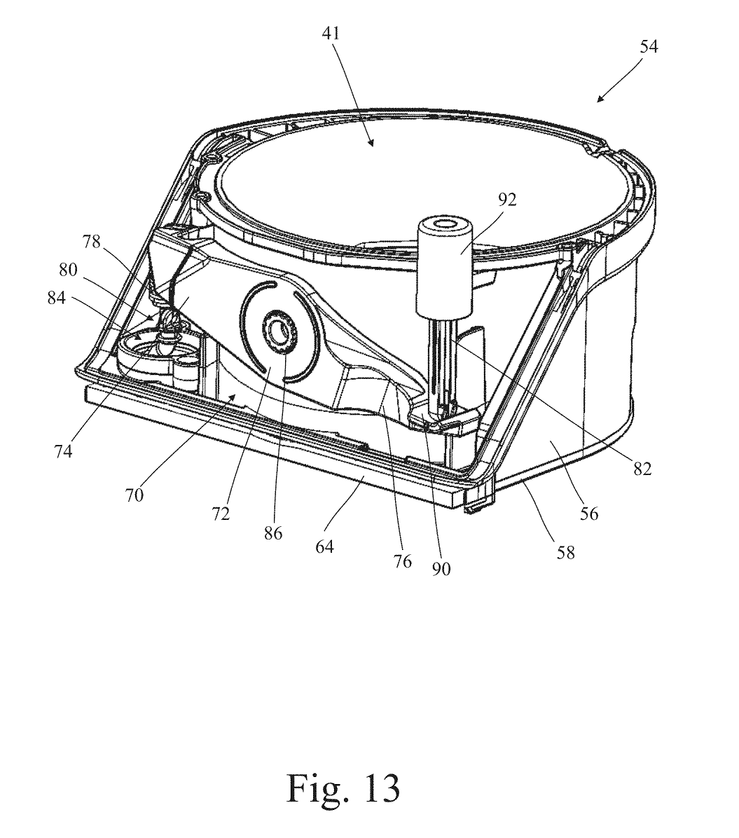

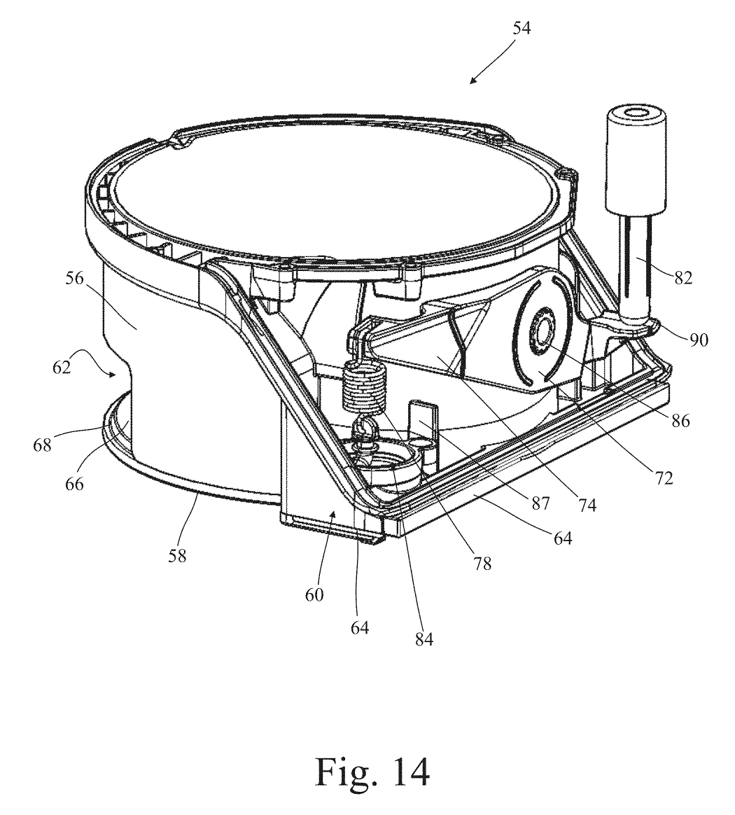

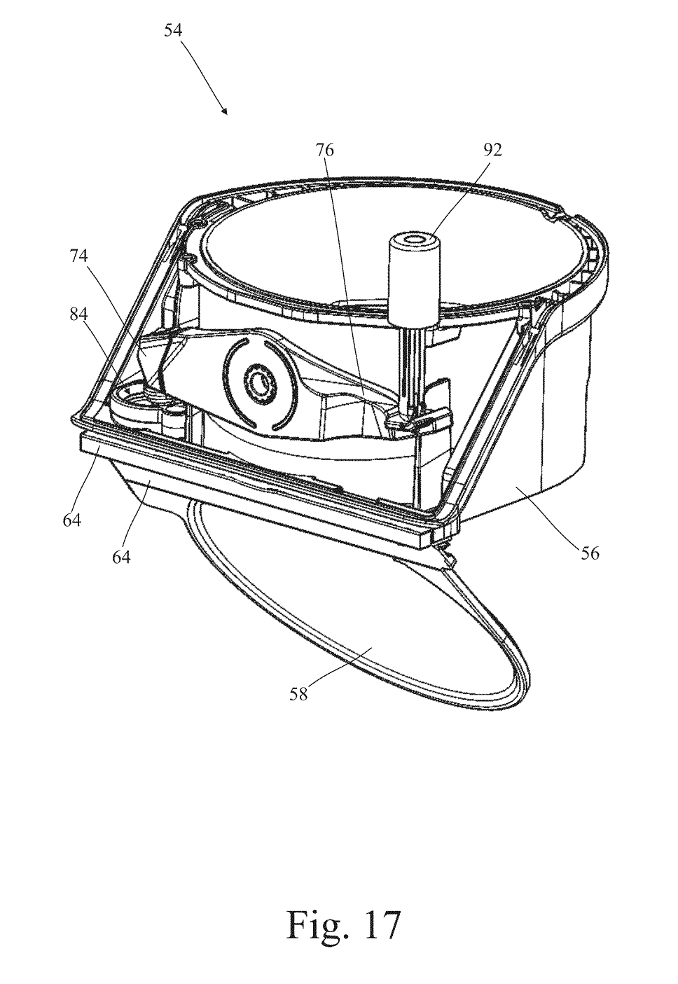

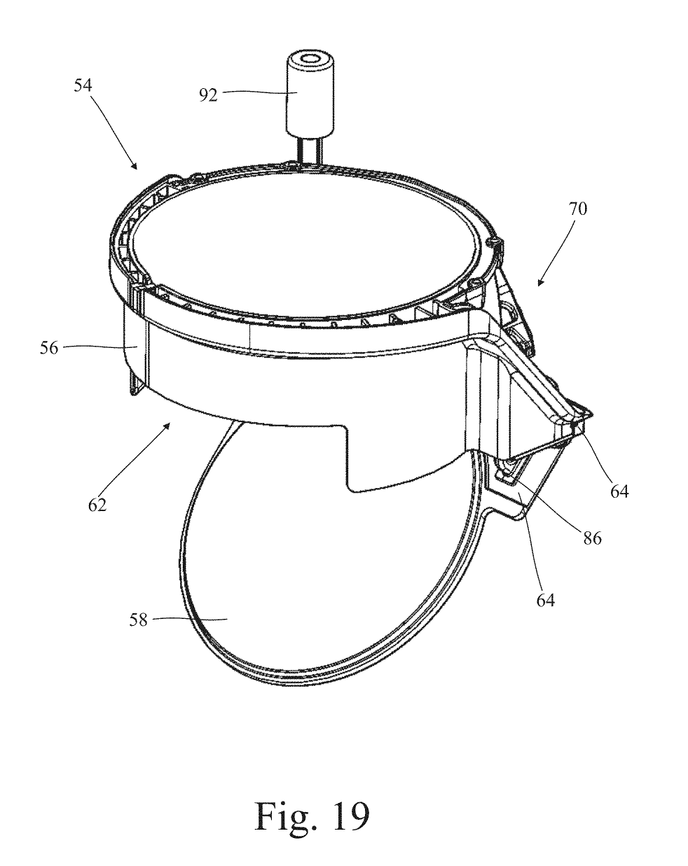

An inner debris collection chamber 54, shown in more detail in FIGS. 13-19, is housed within the outer debris collection chamber 44, and extends downwardly from the debris outlet 41. The inner debris collection chamber 54 comprises a hollow main body 56 and a closure wall 58. The hollow main body 56 depends downwardly from the internal dividing wall 24 and the debris outlet 41, and is generally cylindrical in form. A lower rearmost region of the perimeter of the hollow main body 56 is enlarged to provide a flat interface region 60 for engagement with a corresponding flat interface region of the closure wall 58, and the flat interface region 60 provides the hollow main body 56 with a linear lower rear edge. The hollow main body 56 extends for a little over half of the length of the outer debris collection chamber 44, such that the lower end of the hollow main body 56 is spaced apart from the lower end of the outer wall 20.

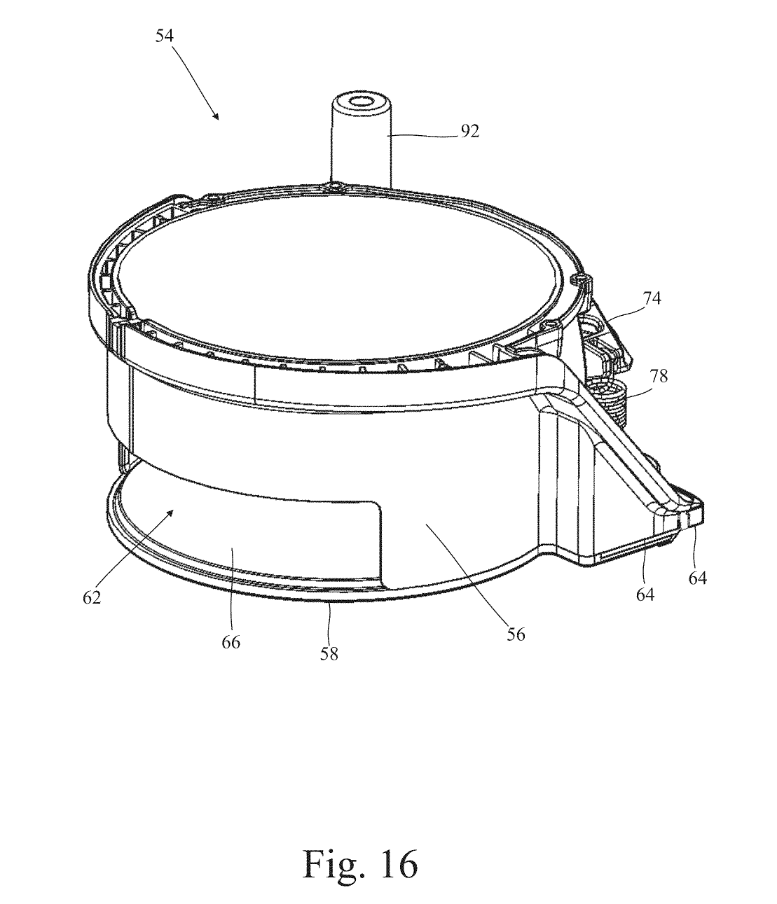

A front-facing region of the hollow main body 56 comprises a cut-out 62, such that when the closure wall 58 is engaged with the lower periphery of the hollow main body 56, in a collecting configuration, the cut-out 62 defines an outlet aperture of the inner debris collection chamber 54. The cut-out 62 follows the shape of the hollow main body 56, such that the aperture defined when the closure wall 58 is engaged with the lower periphery of the hollow main body 56, in a collecting configuration, is slot-like in form. This can be seen most clearly in FIG. 16. The central angle of the cut-out 62 is between 90° and 130°.

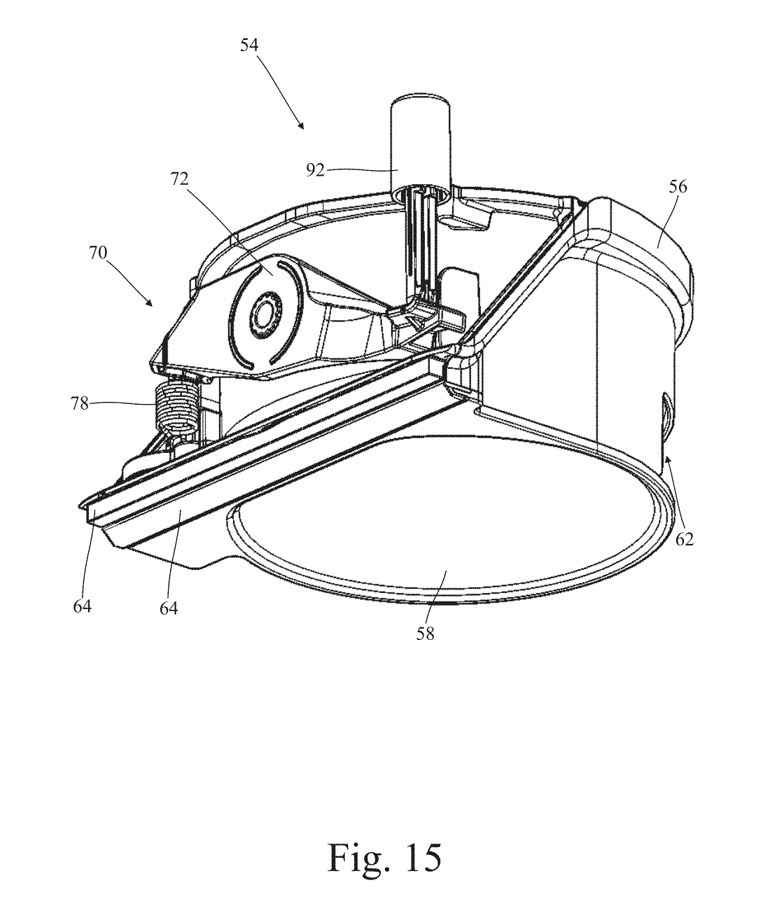

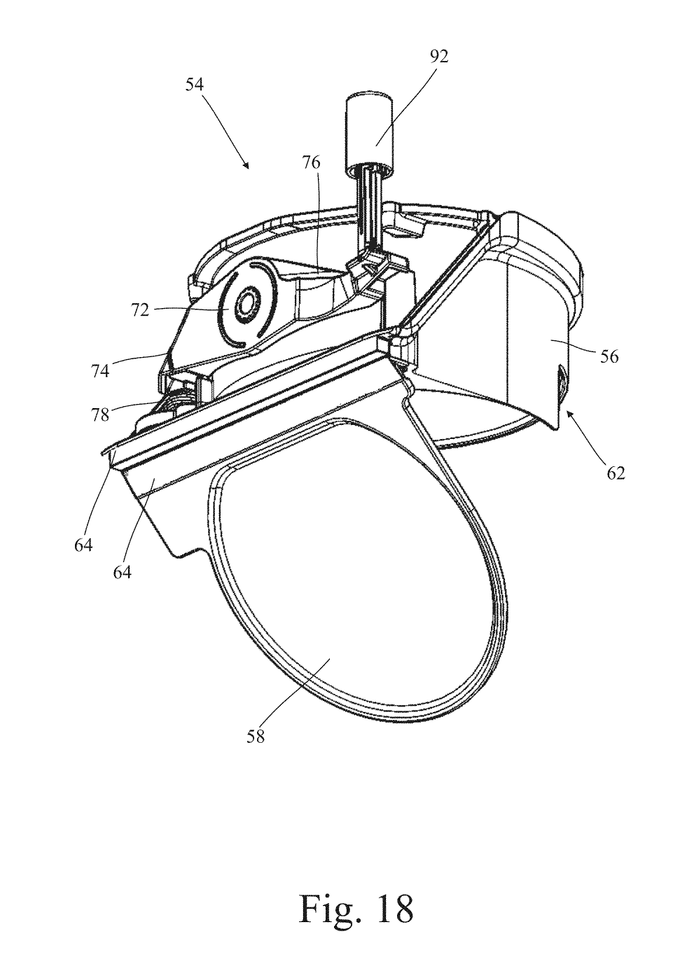

The closure wall 58 is pivotally mounted to the hollow-main body 56 via an elastomeric hinge 64. The elastomeric hinge 64 is overmoulded onto the closure wall 58 and press-fit onto the hollow main body 56 at the linear lower rear edge of the hollow main body 56, such that the elastomeric hinge 64 extends across the entire extent of the linear lower rear edge of the hollow main body 56. The overmoulded section of the elastomeric hinge 64 is generally planar in form, and extends from the press-fit section of the elastomeric hinge 64 which is generally cuboidal in form. This can be seen most clearly in FIGS. 15 and 18. The elastomeric hinge 64 extends entirely between the hollow main body 56 and the closure wall 58, such that no gaps are formed between the hollow main body 56 and the closure wall 58 in a region of the elastomeric hinge 64. The overmoulding sits flush with an inner surface of the generally flattened rear region 28 of the outer wall 20, thereby forming a sealing arrangement between the inner debris collection chamber 54 and the bin 16.

The overmoulded nature of the elastomeric hinge 64, in contrast to a conventional hinge, prevents debris from becoming trapped by the elastomeric hinge 64. This enables the elastomeric hinge 64 to be located in a region of the separating apparatus 10 which is exposed to debris in use, and hence enables use of a hinged opening for the inner debris collection chamber 54.

An upper surface of the closure wall 58 has a raised surface 66. The raised surface 66 does not extend to the edge of the upper surface of the closure wall, such that a step 68 is formed on the closure wall 58. The step 68 is shaped and dimensioned to correspond to a lowermost edge of the hollow main body 56. Thus, when the closure wall 58 is in a collecting configuration, the closure wall 58 lies substantially flush with a lowermost edge of the hollow main body 56.

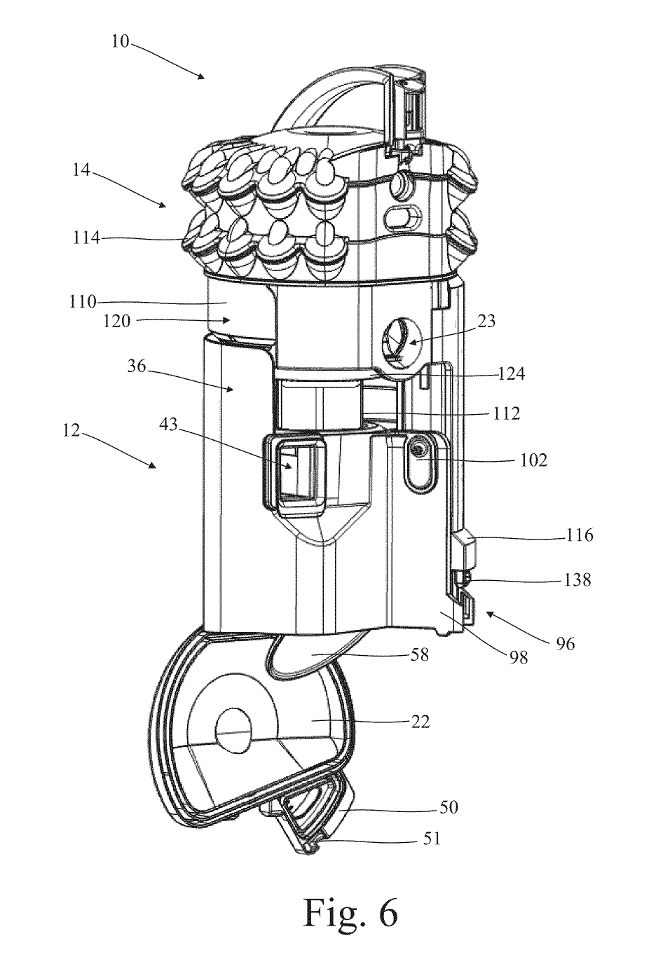

When the closure wall 58 is in a collecting configuration, the entirety of the closure wall 58 is contained within the outer debris collection chamber 44, as can be seen in FIGS. 1-5. When the closure wall 58 is in an emptying configuration, the closure wall 58 is obliquely angled relative to the hollow main body 56, typically at an angle of around 45°-80°, such that the closure wall 58 extends below a lowermost edge of the outer wall 20 of the bin 16, as can be seen in FIGS. 6-11.

Movement of the closure wall 58 about the elastomeric hinge 64 is controlled by an actuation mechanism 70. The actuation mechanism 70 can be seen most clearly in combination with the inner debris collection chamber 54 in FIGS. 13-19.

The actuation mechanism 70 comprises a central hub 72, first 74 and second 76 arms, a spring 78, a hook member 80, and a slidable engagement member 82.

The central hub 72 is generally circular in form, and comprises a central circular aperture for mounting the central hub 72 to a rear surface of the hollow main body 56 of the inner debris collection chamber 54. The central circular aperture is shaped and dimensioned to receive a corresponding mounting lug 86 of the hollow main body 56 of the inner debris collection chamber 54, such that the central hub 72 is rotatable about the mounting lug 86. Thus the mounting lug 86 defines an axis of rotation of the central hub 72, and hence the actuation mechanism 70.

The first 74 and second 76 arms extend outwardly from opposing sides of the central hub 72, and are diametrically opposed. The first 74 and second 76 arms are elongate in form, and are integrally formed with the central hub 72. This may reduce the number of moving parts of the actuation mechanism 70, thereby reducing the complexity of the arrangement, reducing manufacturing costs, and reducing the risk of failure in use.

A distal end of the first arm 74 has a mounting structure in the form of a projection about which a proximal end of the spring 78 is looped. The hook member 80 has a proximal end having a connecting formation connected to a distal end of the spring 78, an elongate main body portion, and a hook (not shown) disposed at a distal end. The spring 78 and hook member 80 extend through a connecting aperture 84 formed in the flat interface region 60 of the hollow main body portion 56 of the inner debris collection chamber 54, and the hook is connected to a corresponding hook receiving formation 86 formed on the closure wall 58. The hook receiving formation 86 is spaced from the overmoulded hinge 64 such that an upward force applied via the hook causes rotation of the closure wall 58 about the overmoulded hinge 64.

An elastomeric member is wrapped about the elongate main body portion of the hook member 80, such that the elastomeric member prevents passage of debris from the inner debris collection chamber 54 through the connecting aperture 84 to the actuation mechanism 70.

A distal end of the second arm 76 defines an upwardly facing engagement surface 90 for engaging the slidable engagement member 82. The upwardly facing engagement surface 90 is substantially planar in form.

The slidable engagement member 82 is a push-rod for applying a force to the upwardly facing engagement surface 90. The push-rod 82 is elongate in form. A proximal end of the push-rod 82 has a rounded end for engagement with the upwardly facing engagement surface 90. A distal end of the push-rod 82 has an enlarged head 92, and the push-rod 82 is mounted within a sliding channel 94 formed on the rear surface of the bin 16, such that the enlarged head 92 covers one end of the sliding channel 94 in a top-hat like arrangement. Thus the enlarged head 92 may prevent debris ingress into the sliding channel 94, and hence may prevent debris from reaching the actuation mechanism 70.

When the distal end of the push-rod 82 engages the upwardly facing engagement surface 90, the second arm 76 experiences a downward force. As the central hub 72 is rotatably mounted to the hollow-main body 56, the downward force applied to the second arm 76 causes rotation of the central hub 72 about the mounting lug 86 in a clockwise direction. This causes the first arm 74, to be raised, thereby raising the closure wall 58 via the connection of the spring 78 and hook member 80. Clockwise rotation of the central hub 72 is limited by engagement of the second arm 76 with a first corresponding projection formed on the inner surface of the bin 16. This is a collecting configuration of the inner debris collection chamber 54, and is shown in FIGS. 1-5 and 13-16.

In the absences of an applied force to the push-rod 82, the closure wall 58 is free to fall under the action of gravity, thereby causing anti-clockwise rotation of the central hub 72 about the mounting lug 86 via the connection of the spring 78 and hook member 80. The central hub 72 is free to return to a position in which the first 74 and second 76 arms extend in a direction parallel with the axis of rotation of the closure wall 58, ie parallel with the elastomeric hinge 64, with the central hub 72 being retained in this position via engagement of the second arm 76 with a second corresponding projection formed on the inner surface of the bin 16 and a third corresponding projection 87 of the actuation mechanism 70. This is an emptying configuration of the inner debris collection chamber 54, and is shown in FIGS. 6-7 and 17-19.

The actuation mechanism 70 is located in a lower region 17 of bin 16, sealed from the outer debris collection chamber 44 by internal walls and the hollow main body 56

The sliding channel 94 is located on a rear surface of the bin 16, within a mounting channel 96 for mounting the second cyclonic separating unit 14 to the first cyclonic separating unit 12, and is closed in form. The mounting channel 96 comprises first 98 and second 100 opposed walls extending longitudinally along a rear surface of the bin 16, in a direction parallel to the separator axis X, and is open in form. The distance between the first 98 and second 100 walls corresponds to the width of a fine dirt collection chamber 116 of the second cyclonic separating unit 14, such that the fine dirt collection chamber 116 is receivable within the mounting channel 96. A lowermost end of the mounting channel 96 is sealed by the secondary sealing projection 50 of the lower wall 22 when the lower wall 22 seals the outer debris collection chamber 44.

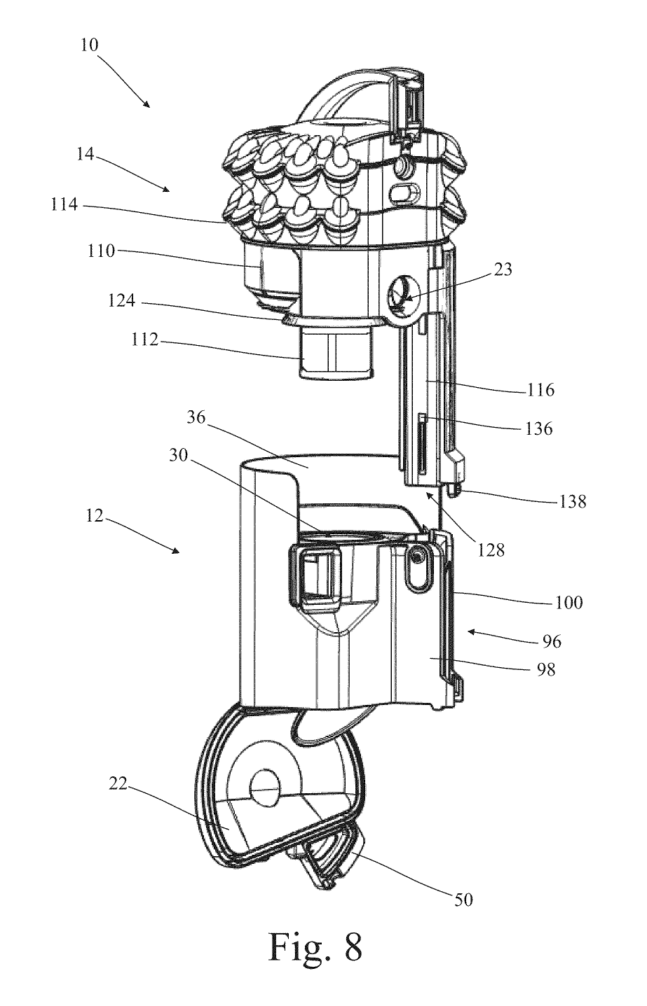

The first wall 98 of the mounting channel 96 has a catch 102 engageable with a corresponding catch projection 136 located on an outer surface of the fine dirt collection chamber 116 of the second cyclonic separating unit 14, to retain the fine dirt collection chamber 116 in mounting channel 96. The catch 102 is releasable to allow complete separation of the first 12 and second 14 cyclonic separating units for cleaning purposes. The first 12 and second 14 cyclonic separating units are shown in such a separated manner in FIGS. 8-10.

Also disposed within the mounting channel 96 is a location projection 104 for engaging a corresponding location recess 132 and biased sleeve 134 of the second cyclonic separating unit 14 when the separating apparatus 10 is in an operable condition. The location projection 104 is upstanding from a location channel 106 formed in a rear surface of the bin 16, and is elongate and planar in form, such that the location projection 104 has a generally ridge-like global form. The location projection 104 extends in a direction parallel to the first 98 and second 100 walls of the mounting channel 96. A lowermost end of the location projection 104 terminates at a location shelf 108 formed at a lowermost end of the location channel 106. The location shelf 108 is flat, extends in a direction substantially orthogonal to the location projection 104, and is shaped to correspond to the shape of the biased sleeve 134.

The second cyclonic separating unit 14 comprises a main body portion 110, a shroud 112, a plurality of secondary cyclones 114, and a fine dirt collection chamber 116.

The main body portion 110 is generally cylindrical in form, yet has a flattened rear surface 118, such that the cross-sectional shape of the main body portion 110 is substantially that of a truncated circle. A front-facing surface of the main body portion 110 has a locating recess 120 shaped and dimensioned to receive a locating wall 36 of the first cyclonic separating unit 12. The main body portion 110 is generally hollow, but comprises a plurality of internal walls. A clean air outlet 122 is disposed on a rear-facing surface of the main body portion 110, and comprises a generally circular aperture formed in the outer wall of the main body portion 110.

The shroud 112 is a tubular and depends downwardly from a lower surface of the main body portion 110. The shroud 112 is formed of a rigid perforated metal plate and a plastic frame, with the perforations providing a fluid inlet for the second cyclonic separating unit 14, and also a fluid outlet for the first cyclonic separating unit 12. Thus the shroud 112 lies downstream of the cyclonic separating chamber 42 of the first cyclonic separating unit 12. The shroud 112 has a shroud axis Y, which extends coaxially with the separator axis X when the first 12 and second 14 cyclonic separating units are connected, and the shroud 112 lies within the cyclonic separating chamber 42. The shroud 112 has a diameter that corresponds substantially to that of the innermost edge 34 of the annular wipe 32. The interior of the shroud 112 is hollow, and is in fluid communication with the plurality of secondary cyclones 114.

A shroud interface seal 124 is disposed at the interface between the shroud 112 and the main body portion 110. The shroud interface seal 124 depends downwardly from a lower surface of the main body portion 110, and has a diameter greater than that of the shroud 112, such that the shroud interface seal 124 surrounds an upper portion of the shroud 112. The shroud interface seal 124 has a diameter which increases in a direction from the interface between the shroud 112 and the main body portion 110 to a free end of the shroud 112, such that the shroud interface seal 124 has a generally conical global form. The shroud interface seal 124 is positioned to engage an upper surface of the upper wall 18 about the circular aperture when the first 12 and second 14 cyclonic separating units are connected in an operable condition.

The plurality of secondary cyclones 114 are arranged in series with the cyclonic separating chamber 42 of the first cyclonic separating unit, and each of the plurality of secondary cyclones 114 are arranged in parallel with one another. The plurality of secondary cyclones 114 are arranged downstream of the shroud 112. The plurality of secondary cyclones 114 are arranged in a stacked array located above the main body portion 110, with secondary cyclones 114 extending about the curved upper perimeter of the main body portion 110.

Debris separated by the plurality of secondary cyclones 114 falls into an internal chamber 126 of the main body portion 110. The internal chamber 126 has a sloped floor, the slope leading toward an inlet of the fine dirt collection chamber 116. Hence debris separated by the plurality of secondary cyclones 114 is directed into the fine dirt collection chamber 116 by the sloped floor of the internal chamber 126.

The fine dirt collection chamber 116 depends downwardly from a rear region of the main body portion 110. The fine dirt collection chamber 116 is elongate in form, extending in a direction parallel to the shroud axis Y, yet spaced apart from the shroud axis Y. The fine dirt collection chamber 116 follows a portion of the curved wall of the main body portion 110, such that the cross-sectional shape of the fine dirt collection chamber 116 is curved in form. The fine dirt collection chamber 116 is shaped and dimensioned to fit within the mounting channel 96 of the first cyclonic separating unit 12. The fine dirt collection chamber 116 is hollow with an open lower end 128, the open lower end 128 being shaped and dimensioned to correspond to the secondary sealing projection 50 of the lower wall 22 of the bin 16.

An outer surface of the fine dirt collection chamber 116 comprises an actuating arm 130 for engaging the push-rod 82 of the actuation mechanism 70. The actuating arm 130 is a rigid tubular arm that depends downwardly from an upper region of the fine dirt collection chamber 116. The actuating arm 130 extends in a direction parallel to the shroud axis Y.

An outer surface of the fine dirt collection chamber 116 also comprises a location recess 132 and biased sleeve 134 for engaging a corresponding location projection 104 of the first cyclonic separating unit 12.

The location recess 132 is elongate in form, and is defined by a tubular channel having a gap formed therein. The gap corresponds to the location projection 104, such that the location projection 104 is able to extend slightly out of the gap when the location projection 104 is held within the location recess 132. The biased sleeve 134 extends about the tubular channel which defines the location recess 132, such that the location recess 132 is hidden by the biased sleeve 134 in the absence of any applied forces to the biased sleeve 134. The biased sleeve 134 is biased in a downward direction parallel to the shroud axis Y.

An outer surface of the fine dirt collection chamber comprises a catch projection 136 for engaging a corresponding catch 102 of the first wall 98 of the mounting channel 96.

A lower surface of the fine dirt collection chamber 116 has a latch 138 for engaging a corresponding latch receiving formation 51 of the lower wall 22. The latch 138 is movably connected to a trigger 140. The trigger 140 extends along the second cyclonic separating unit 14, parallel to the fine dirt collection chamber 116, before extending through the main body portion 110 and terminating adjacent a handle 142.

An operable condition of the separating apparatus 10 is shown in FIGS. 1-5. By an operable condition is meant a condition in which the first 12 and second 14 cyclonic separating units are capable of being operated to remove debris from dirty air, for example by connection to a vacuum cleaner body. An operable condition of the separating apparatus may correspond to a first position of the second cyclonic separating unit 14 and/or a collecting configuration of the inner 54 and/or outer 44 debris collection chambers.

In the operable condition, the first 12 and second 14 cyclonic separating units are connected to one another such that the shroud 112 of the second cyclonic separating unit 12 extends through the circular aperture 30 into the cyclonic separating chamber 42 of the first cyclonic separating unit 12. The separator axis X and the shroud axis Y are co-axial, ie they share a common axis. In such a configuration, the perforations of the shroud 112 define a fluid outlet of the cyclonic separating chamber 42 and a fluid inlet of the second cyclonic separating unit 42. Thus the perforations of the shroud 112 are in fluid communication with the cyclonic separating chamber 42 of the first cyclonic separating unit 12.

The fine dirt collection chamber 116 is located within the mounting channel 96, such that the entirety of the fine dirt collection chamber 116 is located within the mounting channel 96. The latch 138 is engaged with the corresponding latch receiving formation 51 of the lower wall 22, thereby holding the lower wall 22 in a sealing engagement with the perimeter of the outer wall 20, such that the outer debris collection chamber 44 is closed. The latch 138 also holds the second cyclonic separating unit 14 in position relative to the first cyclonic separating unit 12.

The location projection 104 formed on the rear surface of the bin 16 engages the biased sleeve 134, such that the biased sleeve 134 is moved to expose the location recess 132, and the biased sleeve 134 is held in such a position under tension by the location shelf 108. The location projection 104 is housed within the location recess 132.

The actuating arm 130 engages the push-rod 82, such that the push-rod 82 engages the upwardly facing engagement surface 90, and applies a downward force to the second arm. The downward force applied to the second arm 76 means that the actuation mechanism is in a rotated position, such that the first arm 74 is raised. Thus the closure wall 58 of the inner debris collection chamber 54 is held in engagement with the hollow main body 56, such that the closure wall 58 extends in a direction orthogonal to the separator axis X and the shroud axis Y. The inner debris collection chamber 54 is thus in a collecting configuration, as shown in FIGS. 13-16. The spring 78 holds the closure wall 58 under tension, ensuring that the inner debris collection chamber 54 remains in the collecting configuration in spite of forces applied to the closure wall 58 by debris and airflow.

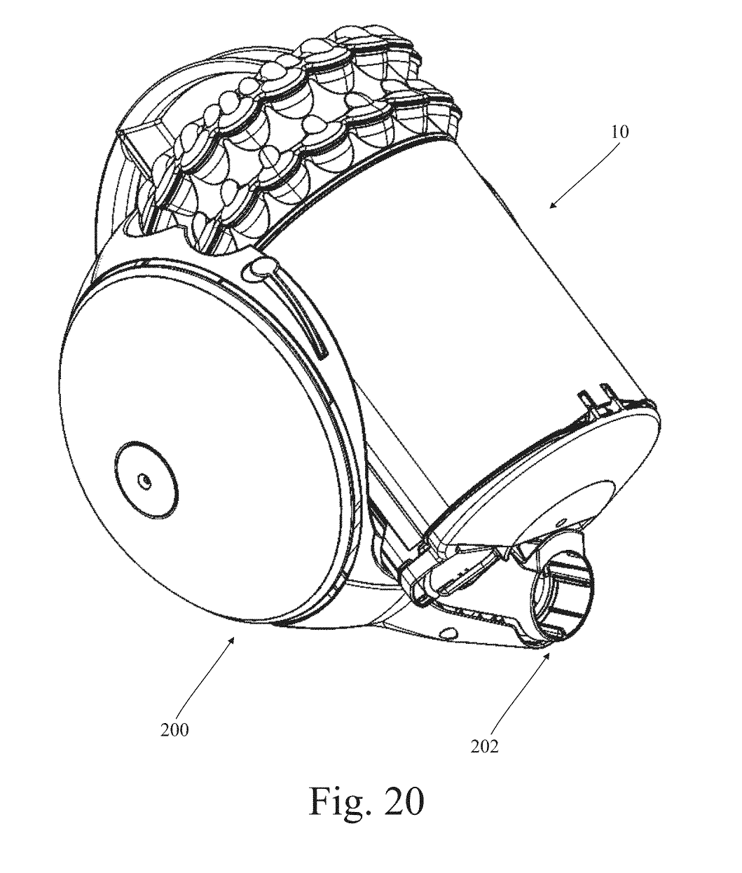

With the separating apparatus 10 in an operable condition as described above, the separating apparatus 10 can be connected to a vacuum cleaner body 200 as shown in FIG. 20.

The vacuum cleaner body 200 has a vacuum cleaner dirty air inlet 202 which is commonly connected to a hose or duct having a nozzle head (not shown), and a motor (not shown) for generating a suction force. In use, dirty air is drawn into the separating apparatus 10, via the vacuum cleaner dirty air inlet 202 and the separating apparatus dirty air inlet 43, by the motor. The form of the internal separator wall 26 causes dirty air to flow within the cyclonic separating chamber 42 in a helical fashion, such that debris is separated by the cyclonic separating chamber 42.

Debris separated by the cyclonic separating chamber 42, ie by the first cyclonic separating unit 12, falls into the inner debris collection chamber 54 via the debris outlet 41. Debris is able to pass from the inner debris collection chamber 54 to the outer debris collection chamber 44 via the cut-out 62 in the hollow main body portion 56. Hence debris separated by the first cyclonic separating unit 12 is collected within the inner 54 and outer 44 debris collection chambers.

The partially cleaned air is able to pass from the cyclonic separating chamber 42, and hence the first cyclonic separating unit 12, to the second cyclonic separating unit 14, via perforations formed in the shroud. The partially cleaned air is fed to the plurality of secondary cyclones 114, which act to separate smaller debris from the airflow. Debris separated by the plurality of secondary cyclones 114 falls into an internal chamber 126 of the main body portion 110, and is directed into the fine dirt collection chamber 116 by a sloped floor of the internal chamber 126. Clean air is able to pass out of the second cyclonic separating unit 14 via the clean air outlet 122.

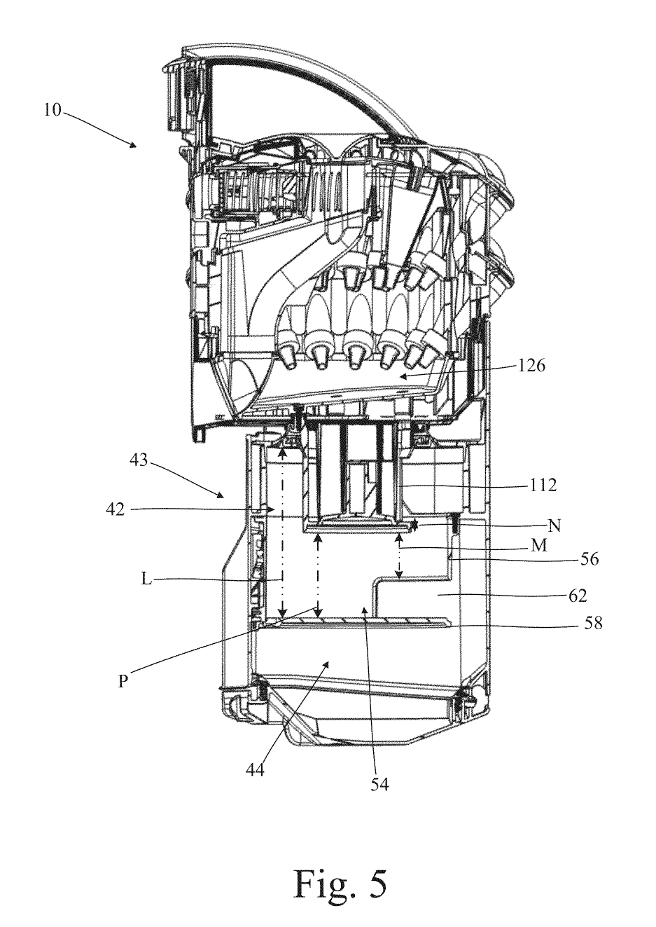

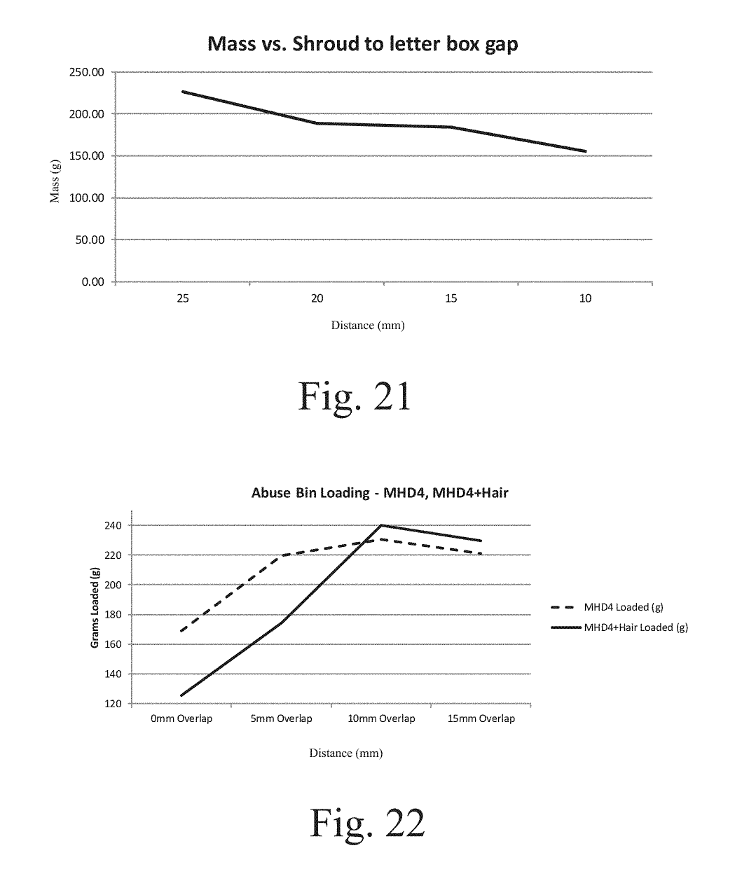

As can be seen in FIG. 5, when the separating apparatus 10 is in an operable condition, the lowermost edge of the shroud 112 is spaced from the uppermost edge of the cut-out 62 in the hollow main body portion 56 of the inner debris collection chamber 54 by a distance M. There is a compromise to be made with regard to distance M, in that a greater distance increases the mass of debris that can be collected before airflow through the shroud 112 drops, but a lower distance is desired for compactness of the separating apparatus. In a presently preferred embodiment, distance M is 20 mm, which provides a relatively large maximum mass of debris that can be collected before airflow through the shroud 112 drops, whilst maintaining a compact arrangement. FIG. 21 shows supporting data for this, and as can be seen from FIG. 21, a relatively high mass of separated debris is achieved at a separation of 20 mm.

In a similar manner, as can be seen in FIG. 5, when the separating apparatus 10 is in an operable condition, the lowermost edge of the shroud 112 is spaced from the closure wall 58 by a distance P, whilst the uppermost edge of the cyclonic separating chamber 42 is spaced from the closure wall 58 by a distance L. There is a compromise to be made here in that it is desirable to make distance P as large as possible to avoid re-entrainment of debris into fluid flowing within the cyclonic separating chamber 42, and to increase the volume of debris that can be collected within the inner debris collection chamber 54, but a shorter distance is desired to provide a compact arrangement. In a presently preferred embodiment, distance L is around 90 mm whilst distance P is around 45 mm. It has been found that distance P being between 40% to 60% of distance L provides reduced re-entrainment and a good level of mass of debris that can be collected before airflow through the shroud 112 drops, whilst maintaining a compact arrangement. The data shown in FIG. 21 was collected when distance P was around 50% of distance L.

As can be seen in FIG. 5, when the separating apparatus 10 is in an operable condition, the lowermost edge of the shroud 112 is spaced from the lowermost edge of the dirty air inlet 43 by a distance N. In a presently preferred embodiment distance N is up to 10 mm, which provides which provides a relatively large maximum mass of debris that can be collected before airflow through the shroud 112 drops, whilst maintaining a compact arrangement. FIG. 22 shows supporting data for this, and as can be seen from FIG. 22, a high mass of separated debris is achieved at a separation of up to 10 mm.

When it is desired to empty debris collected by the separating apparatus 10, the separating apparatus 10 is removed from the vacuum cleaner body 200.

To move the separating apparatus 10 from the operable condition to an emptying condition, a user presses down on the trigger 140 which causes the latch 138 to move out of engagement with the latch receiving formation 51 of the lower wall 22. There is now nothing holding the second cyclonic separating unit 14 in place relative to the first cyclonic separating unit 12. The lower wall 22 falls under the action of gravity to enable debris to be emptied from the outer debris collection chamber 44 and the fine dirt collection chamber 116. The emptying configuration is shown in FIGS. 6-7 and 17-19.

As the biased sleeve 134 is held in position under tension by the location shelf 108, once the latch 138 is released the biased sleeve 134 pushes against the location shelf 108, causing the second cyclonic separating unit 14 to slide relative to the first cyclonic separating unit 12 in a direction along the separator axis X, and hence also along the shroud axis Y.

Thus at the same time as the lower wall 22 falls, the fine dirt collection chamber 116 slides along the mounting channel 96, until the catch projection 136 of the fine dirt collection chamber 116 engages a corresponding catch 102 of the first wall 98 of the mounting channel 96, thereby preventing further separation of the first 12 and second 14 cyclonic separating units.

As the fine dirt collection chamber 116 slides along the mounting channel 96, the actuating arm 130 is moved out of engagement with the push-rod 82, such that the push-rod 82 no longer applies a downward force to the second arm 76 of the actuation mechanism 70. The central hub 72 is thus free to rotate in an anti-clockwise direction about the mounting lug 86, until the central hub 72 returns to an equilibrium position in which the first 74 and second arms 76 lie orthogonal to the separator axis X. As the central hub 72 rotates in an anti-clockwise direction, the first arm 74 is lowered, thereby allowing the closure wall 58 to pivot about the elastomeric hinge 64 into an open position.

Thus, at the same time as the lower wall 22 falls due to release of the latch 138, the closure wall 58 of the inner debris collection chamber 54 is free to fall due to movement of the second cyclonic separating unit 14 relative to the first cyclonic separating unit 12. Debris within the inner debris collection chamber 54 is free to pass to the outer collection chamber 44, and through the bottom of the bin 16 which is no longer closed by the lower wall 22.

As the fine dirt collection chamber 116 slides along the mounting channel 96, the shroud 112 slides through the circular aperture 30 of the upper wall 18 of the bin 16 in an upward direction along the shroud axis Y and hence also the separator axis X. As the shroud 112 slides through the circular aperture 30, the outer surface of the shroud 112 is brushed by the annular wipe 32, such that debris stuck to the outer surface of the shroud 112 is removed. The debris is free to fall into the inner debris collection chamber 54, into the outer debris collection chamber 44, and out through the bottom of the bin 16.

When the relative spacing between the first 12 and second 14 cyclonic separating units is at the maximum extent permitted by the catch 102, the separating apparatus 10 can be said to be in an emptying condition or configuration. The emptying condition or configuration may correspond to a second position of the second cyclonic separating unit 14. When the second cyclonic separating unit 14 is in its second position, the perforations of the shroud 112 are located above the circular aperture 30, such that the perforations of the shroud 112 are not in fluid communication with the cyclonic separating chamber 42 of the first cyclonic separating unit 12. Thus in the emptying configuration or condition, air cannot flow from the first cyclonic separating unit 12 to the second cyclonic separating unit 14. Thus the emptying configuration of condition of the separating apparatus 10 may be an inoperable condition of the separating apparatus 10.

In such a manner the separating apparatus 10 may be automatically moved into an emptying configuration without the need for a user to contact portions of the separating apparatus 10 that have been contaminated by debris in use.

Should it be desired, a user can release the catch 102 to enable complete separation of the first 12 and second 14 cyclonic separating units for cleaning purposes. The first 12 and second 14 cyclonic separating units are shown in such a cleaning condition in FIGS. 8-10.

When it is desired to return the separating apparatus 10 to its operable condition, the fine dirt collection chamber 116 is located within the mounting channel 96, such that the second cyclonic separating unit 14 is slidable toward the first cyclonic separating unit 12 in a direction along the separator axis X. As the second cyclonic separating unit 14 is moved toward the first cyclonic separating unit 12, the shroud 112 re-enters the cyclonic separating chamber 42 via the circular aperture 30, such that the perforations of the shroud 112 are once again in fluid communication with the cyclonic separating chamber 42.

Movement of the second cyclonic separating unit 14 toward the first cyclonic separating unit 12 brings the actuating arm 130 into engagement with the push-rod 82, causing the push-rod 82 to slide into engagement with the upwardly facing engagement surface 90. As the second cyclonic separating unit 14 is advanced, the push-rod 82 applies a downward force to the upwardly facing engagement surface 90, and hence the second arm 76, thereby causing the central hub 72 to rotate about the mounting lug 86 in a clockwise direction. This causes the first arm 74 to be raised, thereby raising the closure wall 58 of the inner debris collection chamber 54 until the closure wall 58 contacts the lower surface of the hollow main body 56. Thus the inner debris collection chamber 54 can be returned to a collecting configuration automatically by movement of the second cyclonic separating unit 14 toward the first cyclonic separating unit 12, without the need for a user to contact the closure wall 58.

As the second cyclonic separating unit 14 is advanced, the location projection 104 formed on the rear surface of the bin 16 engages the biased sleeve 134, such that the biased sleeve 134 is moved to expose the location recess 132, and the biased sleeve 134 is held in such a position under tension by the location shelf 108. The location projection 104 is housed within the location recess 132.

Once the second cyclonic separating unit 14 has been slid toward the first cyclonic separating unit 12 by a maximum possible extent, the lower wall 22 of the bin 16 can be raised by a user, such that the latch receiving formation 51 of the lower wall 22 is moved into engagement with the latch 138 of the second cyclonic separating unit 14. Thus the second cyclonic separating unit 14 is retained in position relative to the first cyclonic separating unit 12 by the latch 138, and the separating apparatus 10 is once again in an operable condition. The separating apparatus 10 can then be reattached to the vacuum cleaner body 200 for subsequent use.

Alternatively, the process of returning the separating apparatus 10 to an operable condition can be begun by a user raising the lower wall 22, such that the lower wall 22 contacts the closure wall 58 of the inner debris collection chamber 54, thereby raising the closure wall 58 and beginning clockwise rotation of the actuation mechanism 70. The process is then finished by sliding the second cyclonic separating unit 14 toward the first cyclonic separating unit 12, as described above.

1. Separating apparatus for a vacuum cleaner, the separating apparatus comprising:
a cyclonic separating chamber having a separator axis;
a shroud disposed within the cyclonic separating chamber;
an inner debris collection chamber for collecting debris separated by the cyclonic separating chamber; and
an outer debris collection chamber for collecting debris separated by the cyclonic separating chamber, the inner debris collection chamber comprising a base and a debris outlet in fluid communication with the outer debris collection chamber,
wherein a shortest distance between the shroud and the base in a direction parallel to the separator axis is between 40% and 60% of a largest distance between the cyclonic separating chamber and the base in a direction parallel to the separator axis.

2. The separating apparatus of claim 1, wherein the shortest distance is between 45% and 55% of the largest distance.

3. The separating apparatus of claim 1, wherein a height of the debris outlet in a direction parallel to the separator axis is between 20 mm and 30 mm.

4. The separating apparatus of claim 1, wherein the debris outlet extends along the inner debris collection chamber in a circumferential manner, and comprises a central angle of between 90° to 130°.

5. The separating apparatus of claim 1, wherein the separating apparatus comprises a dirty air inlet, and a shortest distance between the dirty air inlet and a lowermost edge of the shroud in a direction parallel to the separator axis is between 0 mm and 15 mm.

6. A vacuum cleaner comprising a separating apparatus the separating apparatus comprising:
a cyclonic separating chamber having a separator axis;
a shroud disposed within the cyclonic separating chamber;
an inner debris collection chamber for collecting debris separated by the cyclonic separating chamber; and
an outer debris collection chamber for collecting debris separated by the cyclonic separating chamber, the inner debris collection chamber comprising a base and a debris outlet in fluid communication with the outer debris collection chamber,
wherein a shortest distance between the shroud and the base in a direction parallel to the separator axis is between 40% and 60% of a largest distance between the cyclonic separating chamber and the base in a direction parallel to the separator axis.
